(19) United States
(12) Patent Application Publication
(10) Pub. No.: US 2011/0209774 A1
(43) Pub. Date: Sep. 1, 2011

(54) Bidet device self cleaning nozzle

(75) Inventor: Warren Smith, Boulder City, NV (US)

(73) Assignee: American Biffy Company, Ltd.

(21) Appl. No.: 11/020,868

(22) Filed: Dec. 23, 2004

Related U.S. Application Data
(63) Continuation-in-part of application No. 10/350,539, filed on Jan. 24, 2003, now Pat. No. 6,874,173.

(51) Int. Cl. B08B 3/00

(52) U.S. Cl. 137/15.05

(57) ABSTRACT

An improved bidet device is set forth which includes a self cleaning spray tube having a housing with a first open end with respect to a water supply and a second open downstream end. A nozzle disposed within the housing, the nozzle having a plurality of radial holes therethrough and being adapted to receive water from the first open end of the housing. A spring wound about the nozzle, the spring tending to to retain the nozzle within the housing. Whereby water delivered to first open end of the housing flows through the radial holes of the nozzle, such that water is discharged from the holes and urges the nozzle to move from a first nozzle position within the housing to a second nozzle position outside the housing. Water discharged from the radial holes bathes an external surface of the nozzle such that the nozzle is self-cleaning. A method for cleaning a nozzle having a water supply is also disclosed.

### CROSS REFERENCE TO RELATED APPLICATIONS

This application is a continuation in part of a commonly owned U.S. application Ser. No. 10/350,539, filed Jan. 24, 2003 entitled “Improved Bidet Device”.

### FIELD OF THE INVENTION

The present invention relates to bidet devices of the type which are added to an existing toilet, and more particularly to such devices which provide for back flow prevention and venting.

### BACKGROUND

Bidet devices are known as described in my prior U.S. Pat. Nos. 5,933,881 and 6,487,732 the disclosures of which are hereby incorporated by reference. The devices of my prior patents provide a structure for attachment thereof to an existing toilet (water closet) and which supports a valve structure for positioning the spray tube and for turning on the supply of water. In response to water being provided to the spray tube, a sheet of water is discharged from the holes. The orientation of the holes causes the sheet of water to be directed towards the underside of the torso of the person seated upon the seat.

While the spray tube is withdrawn to a rearward portion of the bowl, the toilet can be used for the usual toilet facility activities. However, while the spray tube is in the withdrawn position it may still be exposed to either droppings of fecal matter or urine.

There is a need for an improvement which provides for a simple, economical means to further protect the spay tube from contamination by such exposure and, because of the occurrence of such unwanted exposure, to routinely clean the spray tube.

### SUMMARY

There is provided according to the present invention, an improved bidet device which protects the spray tube or nozzle by containing it within a housing when the spray is turned off. When the spray is turned on, the nozzle is bathed in clean water and then urged outside of its protective housing where the spray from the nozzle is directed towards the underside of the user. When water flow to the spray tube stops, the nozzle retracts back within its housing.

According to the present invention an improved bidet device is set forth of the type having a frame to mount the device between the toilet blow, a handle mounting a water tube that passes over the rim of the bowl to the interior thereof. The handle is mounted to the frame for rotation of the tube from a rest position to positions for spraying the underside of a torso of a person seated on the bowl. The spray tube includes upwardly directed spray holes. Water, from a supply, is directed to the tube for spraying of the torso through the holes. A protective housing is provided for the spray tube. When the water is turned on, a nozzle within the spray tube is bathed in clean water and the nozzle emerges from the housing to spray the underside of the torso as previously described. When the water into which the spray tube is turned off, the nozzle returns to its position within the housing. Thereby, the nozzle is cleaned before each use.

Accordingly, a simple, inexpensive self-cleaning and retractable nozzle is provided. These features, alone and in combination with others, provide an ergonomic, simple and effective self-cleaning bidet device.

### BRIEF DESCRIPTION OF THE DRAWINGS

These and other features and advantages will become appreciated as the same becomes better understood with reference to the description, claims and drawings wherein;

FIG. 1 is a perspective view, with a part broken away, of a portion of a prior art apparatus;

FIG. 2 is a perspective view of apparatus of FIG. 1;

FIG. 3 is a side elevation of a water tube in FIG. 1;

FIG. 4 is a plan view, with a part broken away, of the apparatus of FIG. 1;

FIG. 5 is a side elevation, with parts broken away, of a valve block and a hose bib of FIG. 1;

FIG. 6 is a front view of a valve chamber insert of FIG. 5;

FIG. 7 is a side elevation of the valve chamber insert of FIG. 6;

FIG. 8 is a bottom view of the valve chamber insert of FIG. 7;

FIG. 9 is a view of the valve chamber insert of FIG. 7 taken along the line 9-9;

FIG. 10 is a view of the valve chamber insert of FIG. 5 taken along the line 10-10;

FIG. 11 is a side elevation, with parts broken away, of a handle of the apparatus of FIG. 2;

FIG. 12 is a side view of FIG. 11 taken along the line 12-12;

FIG. 13 is an expanded view of an embodiment of the present inventions;

FIG. 14(a) is an end view of an embodiment of the present invention;

FIG. 14(b) is a top view of an embodiment of the present invention;

FIG. 14(c) is a side cutaway view of an embodiment of the present invention;

FIG. 15(a) is an end view of an embodiment of the present invention;

FIG. 15(c) is a side cutaway view of an embodiment of the present invention;

FIG. 16(a) is a side cutaway view of an embodiment of the present invention; and

FIG. 16(b) is a side cutaway view of an embodiment of the present invention.

### DETAILED DESCRIPTION

1. The Existing, Prior Device

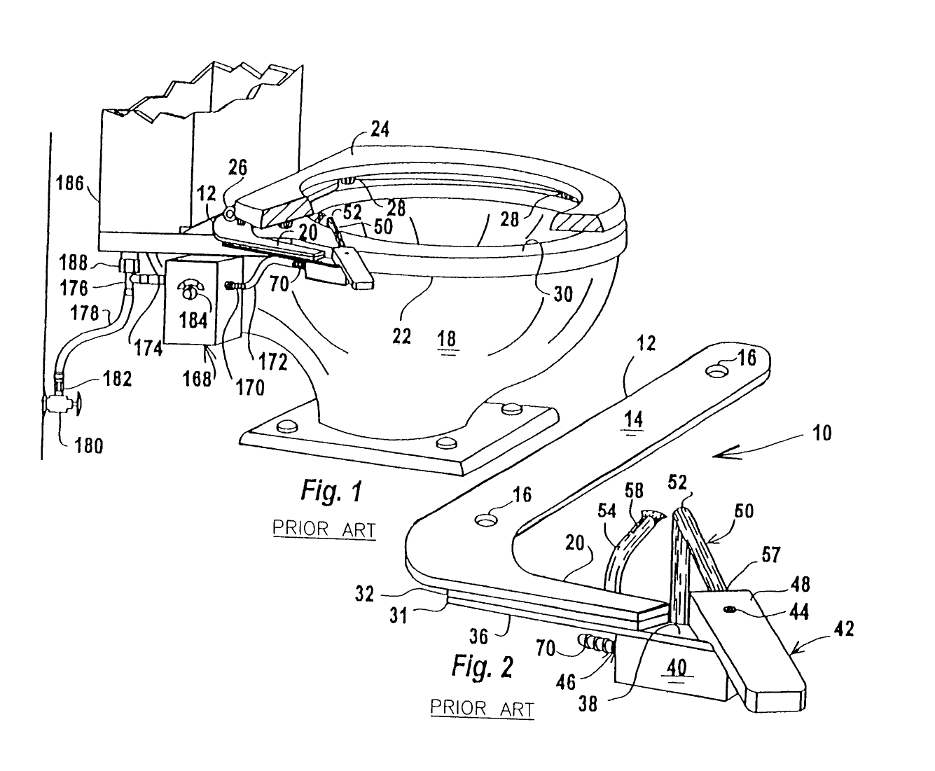

As shown in FIGS. 1-4, a cleansing apparatus 10 (FIG. 2) includes an L shaped toilet mounting frame 12 that is preferably made from plastic. The frame 12 has a long side 14 with a pair of mounting holes 16 that have a spacing there between that is substantially equal to the spacing between mounting holes of a toilet seat. The spacing between the toilet seat mounting holes is standardized in the United States.

The long side 14 is positioned upon the rear of the exterior of a toilet bowl 18 (FIG. 1) of a toilet, with the holes 16 aligned with corresponding holes (not shown) of the bowl 18. A short side 20 of the frame 12 extends on the exterior bowl 18 along an outer edge 22 thereof.

A toilet seat 24 includes a hinged section 26 where the toilet seat mounting holes are located. Mounting bolts (not shown) pass through the holes of the bowl 18, the holes 16 and the toilet seat mounting holes whereby the long side 14 is sandwiched between the rear of the exterior of the bowl 18 and the hinged section 26. The bolts are screwed into nuts (not shown).

A plurality of standoffs 28 are connected to the bottom of the seat 24 in any suitable manner. The standoffs 28 create a space between the seat 24 and a rim 30 of the bowl 18 that is used in a manner described hereinafter. The use of a standoff to create a space between a toilet seat and a toilet bowl is well known in the art and is commonly provided on standard toilet seats.

A plastic spacer strip 32 (FIG. 2) is cemented between the short side 20 and a plastic component strip 34. The strip 34 has a surface 36 whereon a plastic valve block 40 is carried. A plastic handle 42 is carried on a surface 38 of the strip 34. The handle 42 is rotatable upon the surface 38 about a screw 44. The valve block 40 is connected to a hose bib 46.

A proximal end 51 of a plastic water tube 50 extends from an end 48 of the handle 42. More particularly, the tube 50 extends horizontally from the end 48. Because of the strip 32, the tube 54 passes beneath the seat 24, over the rim 30 (FIG. 1) to the interior of the bowl 18 via the space created by the spacers 28.

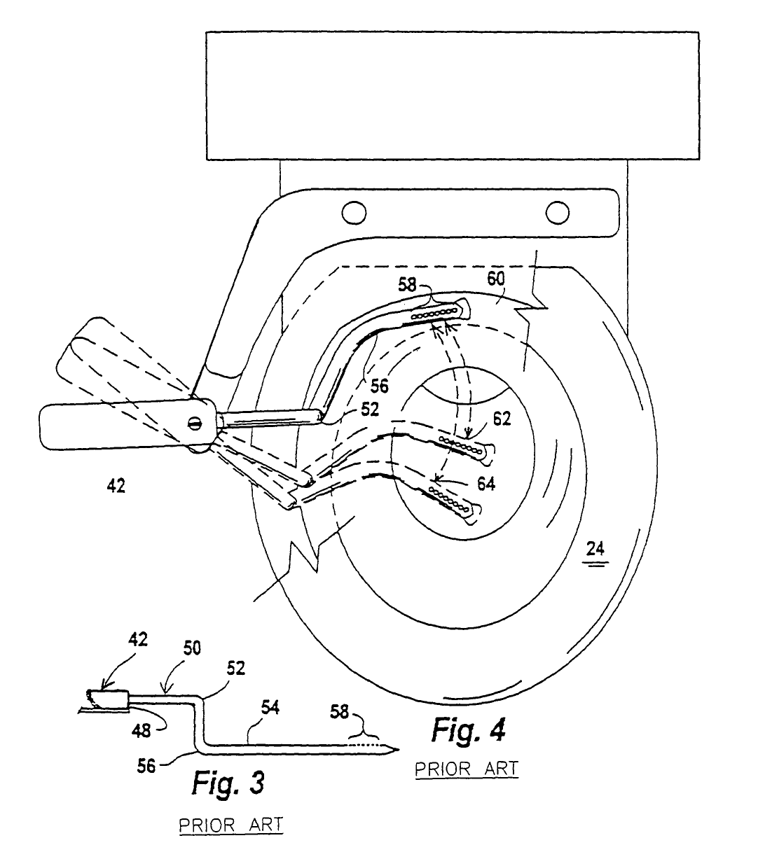

The tube 50 has a first right angle bend 52 (FIGS. 1-3) that causes a distal portion 54 (FIG. 3) of the tube 50 to extend below the rim 30. The tube 50 additionally has a second right angle bend 56 that causes the distal portion 54 to extend over water within the bowl 18. The distal portion 54 has a plurality of longitudinally aligned holes 58 therein (FIGS. 1-4).

In response to water being provided to the proximal end 51, a sheet of water is discharged from the holes 58. The orientation of the holes 58 causes the sheet of water to be directed toward the underside of the torso of a person seated upon the seat 24.

The sheet of water has been found to cause less splashing and provide a superior cleansing than a fountain of water typically produced by devices of the prior art. Additionally, a wide coverage provided by the sheet of water obviates both the lateral movement of the person and a precise targeting of the water.

The spray tube or nozzle 50 is at a withdrawn location when the distal portion 54 is withdrawn to a rear portion 60 of the bowl 18 (FIG. 4). When the nozzle 50 is withdrawn, the toilet can be used for the usual facility activities without the nozzle 50 being subjected either to droppings of fecal matter or urine. For reasons explained hereinafter, water is not discharged from the holes 58 when the tube 50 is withdrawn. When the tube 50 is not withdrawn, water that flows into the hose bib 46 passes through the valve block 40 and the handle 42 to the tube 50. The water is discharged from the holes 58.

When, for example, the handle 42 is rotated to cause the distal portion 54 to pivot to a location 62, the tube 50 is in an anal cleansing position, whereby the sheet of water cleanses the anus of a woman seated upon the seat 24. When the handle 42 is rotated to cause the distal portion 54 to pivot to a location 64, the tube 50 is in a vaginal cleansing position whereby the sheet of water cleanses the woman's vagina. It should be understood that the handle 42 is rotatable to cause the distal portion 54 to be at any location that is intermediate to the locations 62, 64 whereby the sheet of water is moved to cleanse the woman's perineal skin area.

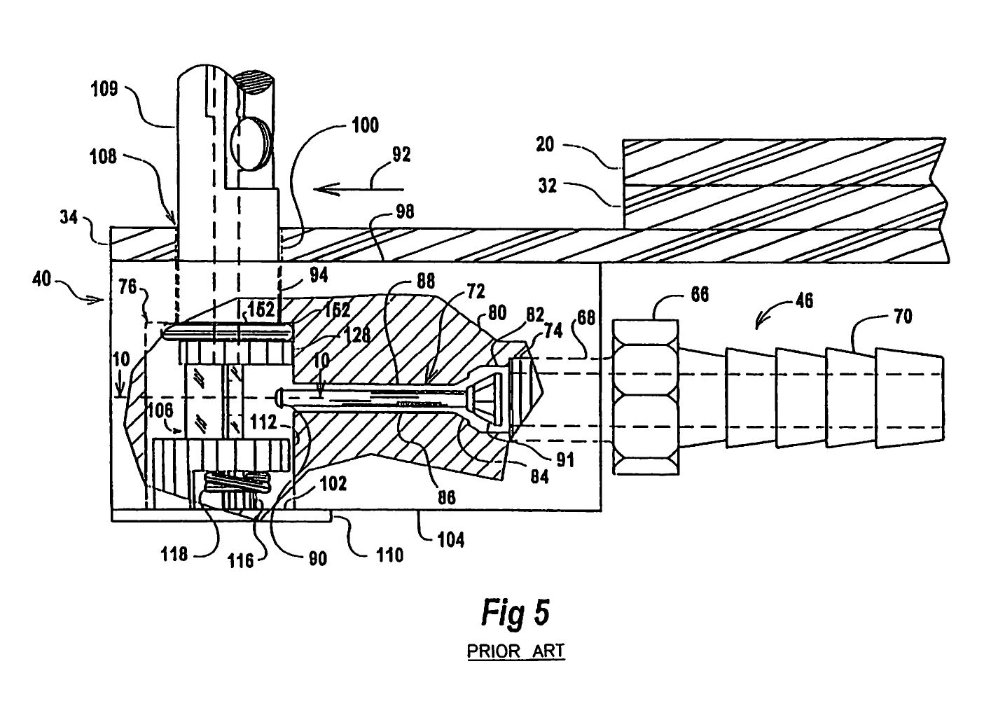

As shown in FIG. 5, the hose bib 46 has a mid-section 66 in the shape of a hexagonal bolt head. The hose bib 46 additionally has a threaded end 68 and a scalloped end 70. As explained hereinafter, the end 68 is screwed into the valve block 40. Hose bibs are well known to those skilled in the art.

A passageway 72 within the valve block 40 extends from a widened threaded section 74 thereof to a valve chamber 76. The end 68 screws into the threaded section 74. A wrench (not shown) may be used to turn the mid-section 66 to screw the end 68 into the threaded section 74.

The passageway 72 includes a coupling section 80 that has the general shape of a funnel. A wide end 82 of the coupling section 80 is connected to the threaded section 74. A narrow end 84 of the coupling section 80 is connected to one end of a narrowed cylindrical section 86 of the passageway 72; the other end is contiguous with an opening in the valve chamber 76. Accordingly, there is a path for water that extends from the hose bib 46 to the valve chamber 76.

A valve stem 88 is disposed mostly within the passageway 72. The valve stem 88 has a rounded end 90. The end 90 extends into the interior of the valve chamber 76.

The valve stem 88 additionally has an end 91 that has the shape of a right truncated cone. The end 91 is disposed within the coupling section 80.

The pressure of water provided via the hose bib 46 urges the valve stem 88 to move in the direction of an arrow 92. Because of its conical shape, the end 91 occludes the passageway 72 to prevent a flow of water to the valve chamber 76. As explained hereinafter, the passageway 72 is cleared when the handle 42 is rotated to cause the tube 50 to move from the rest position.

A hole 94 extends from the valve chamber 76 to a top surface 98 of the valve block 40. The hole 94 is coaxial with a hole 100 through the strip 34. The holes 94, 100 have substantially the same diameter.

A hole 102 extends from the valve chamber 76 through a bottom surface 104 of the valve block 40. A plastic valve chamber insert 106 is inserted through the hole 102 into the valve chamber 76. The insert 106 includes a transfer tube 108 that has a section 109 that protrudes through the hole 100. The transfer tube 108 has a generally cylindrical shape. After the insertion, the hole 102 is sealed by a plastic sheet 110 that is cemented to a bottom surface 104 of the valve block 40.

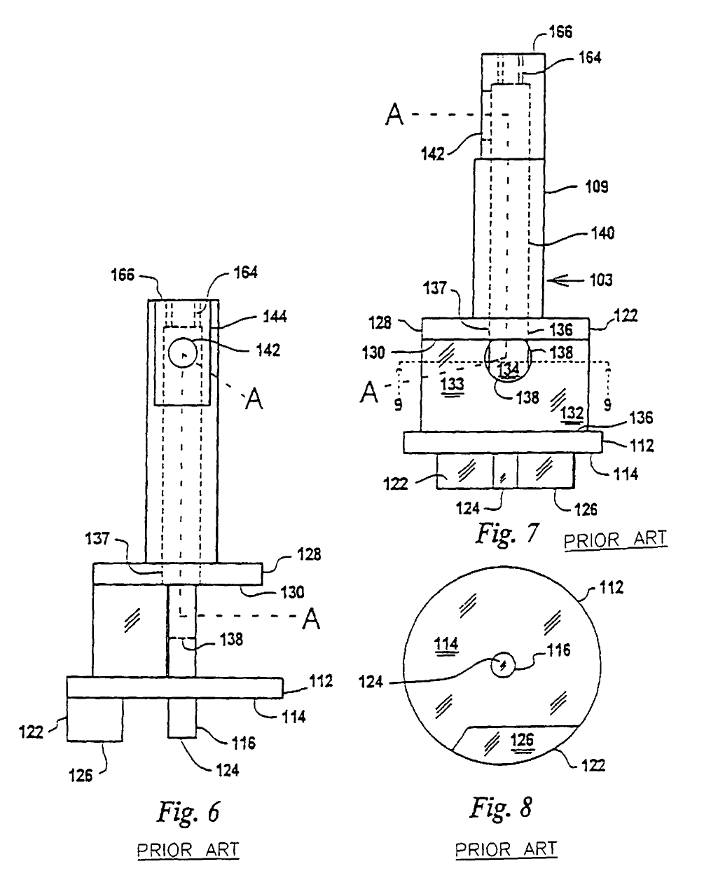

As shown in FIGS. 6-8, the insert 106 includes a disc 112 with a surface 114 that is integrally connected to a cylindrical capstan 116. The disc 112 and the capstan 116 are coaxial.

A coil spring 118 (FIG. 5) is would about the capstan 116. One end of the spring 118 (not shown) is fixedly connected to the capstan 116; the other end is fixedly connected to the wall of the valve chamber 76. The purpose of the spring 118 is explained hereinafter.

The disc 112 is integrally connected to a support member 122 (FIGS. 6-8). A surface 124 (FIG. 8) of the capstan 116 and a surface 126 of the member 122 are rotatably supported upon the sheet 110 (FIG. 5). Accordingly, a rotary movement of the insert 106 causes a corresponding rotary sliding movement of the capstan 116 and the member 122 upon the sheet 110.

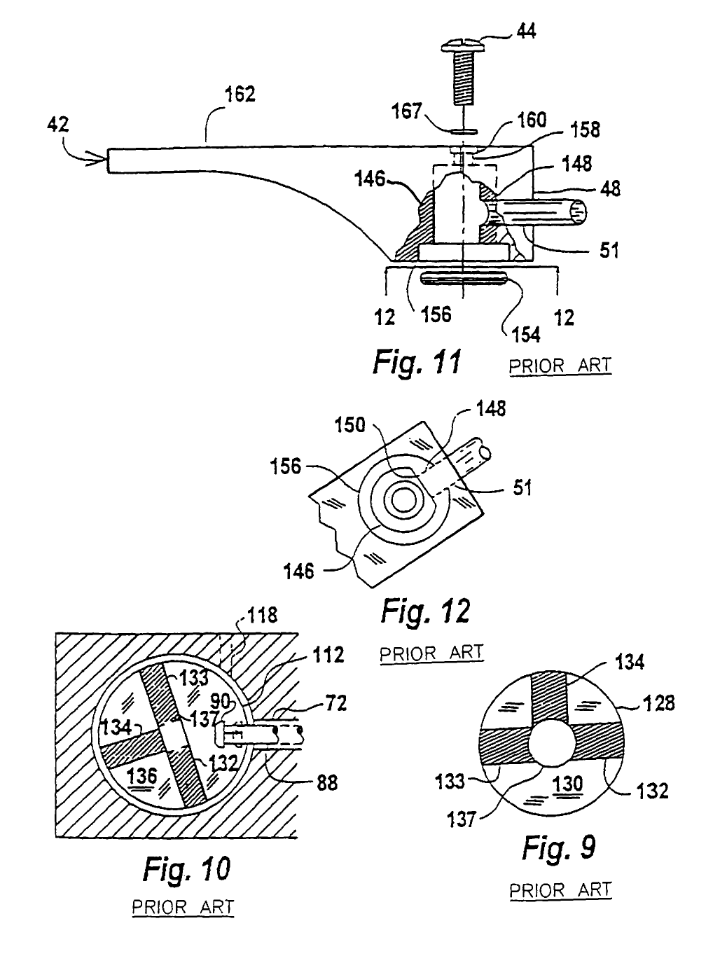

As shown in FIGS. 9 and 10, with continuing reference to FIGS. 6 and 7, the insert 106 additionally includes a disc 128 with a surface 130 that is integrally connected to vanes 132-134 (FIG. 9) at distal ends thereof. Proximal ends of the vanes 132-134 (FIG. 10) are integrally connected to a surface 136 of the disc 112.

The insert 106 is rotatable to cause the vane 132 to move the end 90 in a direction opposite from the direction of the arrow 92, thereby clearing the passageway 72. The purpose of the vanes 133, 134 is to provide structural support for a separation that is maintained between the discs 112, 128.

It should be understood that the range of angles of rotation of the insert 106 that causes the vane 132 to clear the passageway 72 is directly related to the widths of the vane 132 and the end 90. The widths are chosen to cause the passageway 72 to be cleared when the location of the distal portion 54 is within a range substantially defined by the locations 62, 64. As explained hereinafter, the rotation of the discs 112, 128 is caused by a corresponding rotation of the handle 42.

The disc 128 has a central hole 137 there through that extends to an intersection of the vanes 132-134 (FIG. 9). Additionally, a hole 138 extends through an intersection of the vanes 132, 133 to an edge of the vane 134. There is substantially a ninety-degree angle of intersection between the holes 137, 138.

The transfer tube 108 has an axial 140 that is contiguous with the hole 137. The holes 137, 140 have substantially the same diameter.

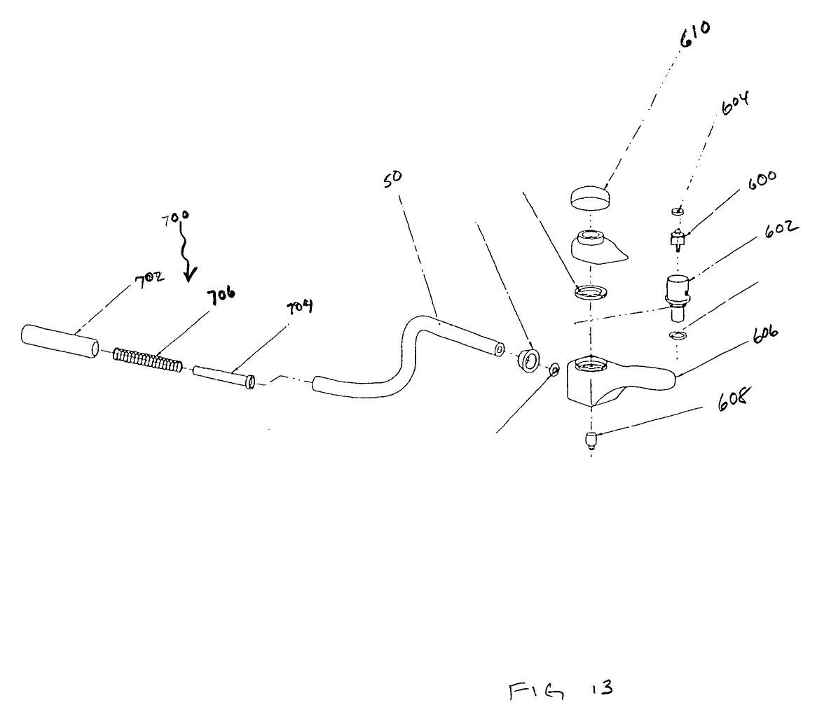

The protruding section 109 has a discharge hole 142 therein that has an angle of intersection of substantially ninety degrees with the hole 140. The protruding section 109 additionally has a flattened outer surface 144 in the region of the hole 142. Therefore, when the passageway 72 is cleared, water that enters the valve chamber 76 passes through the transfer tube 108 and is discharged therefrom through the discharge hole 142. The path of water through the discharge tube 108 is along a path A-A shown in broken lines (FIGS. 6 and 7). As explained hereinafter the flattened wall 144 is used to couple the tube 108 to the handle 42. As shown in FIGS. 11 and 12, the handle 42 has a generally cylindrical coupling hole 146 therein that has substantially the same diameter as the transfer tube 108 (FIGS. 6 and 7).

An outlet hole 148 extends through the end 48 and has an angle of intersection of substantially ninety degrees with the coupling hole 146. The proximal end 51 is disposed within the hole 148 and is preferably cemented therein whereby the tube 50 extends from the end 48 as described hereinbefore.

The coupling hole 146 has a flattened surface 150 in the region of the intersection with the hole 148. In this embodiment, the shape of the coupling hole 146 is complimentary to the shape of the protruding section 109.

The protruding section 109 is disposed within the coupling hole 146 with the flattened surfaces 144, 150 in an abutting relationship. The complimentary shapes prevent a rotation of the handle 42 relative to the transfer tube 108. In other words, when the handle 42 is rotated, the insert 106 is rotated. Hence, the handle 42 is rotatable to cause either the occlusion or the clearing of the passageway 72. Moreover, the occlusion occurs when handle 42 is rotated to cause the tube 50 to be in the rest position.

The holes 142, 148 are in an alignment that is maintained by the complimentary shapes. The alignment is essential to providing a desired transfer of water through the transfer tube 108 to the tube 50 through the handle 42.

The spring 118 urges the transfer tube 108 to rotate in a direction that results in the occlusion the passageway 72. Because the relative rotation is prevented, the handle 42 is urged to rotate in a direction that moves the tube 50 to the rest position. Therefore, when the woman releases the handle 42, the tube 50 is rotated to the rest position and no water flows there through, whereby the toilet can be used for usual toilet facility activities.

Preferably, an O-ring 152 (FIG. 5) is maintained about the transfer tube 108 to prevent a leakage of water from the valve block 40 between the transfer tube 108 and the hole 94. Similarly, an O-ring 154 (FIG. 11) is preferably retained within a recess 156 within the handle 42 to prevent a leakage of water from the coupling hole 146.

The coupling hole 146 is contiguous with a cylindrical coupling section 158 within the handle 42. The coupling section 158 is contiguous with an O-ring recess 160 that extends through a top surface 162 of the handle 42. Additionally, the hole 140 is contiguous with a threaded hole 164 (FIGS. 6 and 7) that extends through a top 166 of the protruding section 109.

When the protruding section 109 is within the coupling hole 146, the screw 44 is screwed into the hole 164, thereby securely connecting the handle 42 to the transfer tube 108. Additionally, an O-ring 167 is disposed within the recess 160 to prevent a leakage of water from the coupling hole 146. O-rings are well known in the art.

The hose bib 46 is connected at its scalloped end 70 (FIG. 1) to a water heater 168 at an outlet end 170 thereof through a flexible tube 172. An inlet end 174 of the heater 168 is connected through a TEE connector 176 and a flexible tube 178 to a manual control valve 180 at an outlet port 182 thereof whereby water from the port 182 is available to the hose bib 46 via the heater 168.

The heater 168 has a manual control knob 184 that is adjustable to cause water provided at the outlet end 170 to be at a desired temperature. The heater 168 is of a type well known in the art.

Preferably, the heater 168 includes a compartment where medication may be placed for a time release into the water provided at the outlet end 170 whereby a medicated solution is provided at the outlet end 170. The medicated solution may be desirable when a woman who has had an episiotomy uses the apparatus 10. Apparatus for providing the timed release of the medication is well known to those skilled in the art.

2. The Present Invention

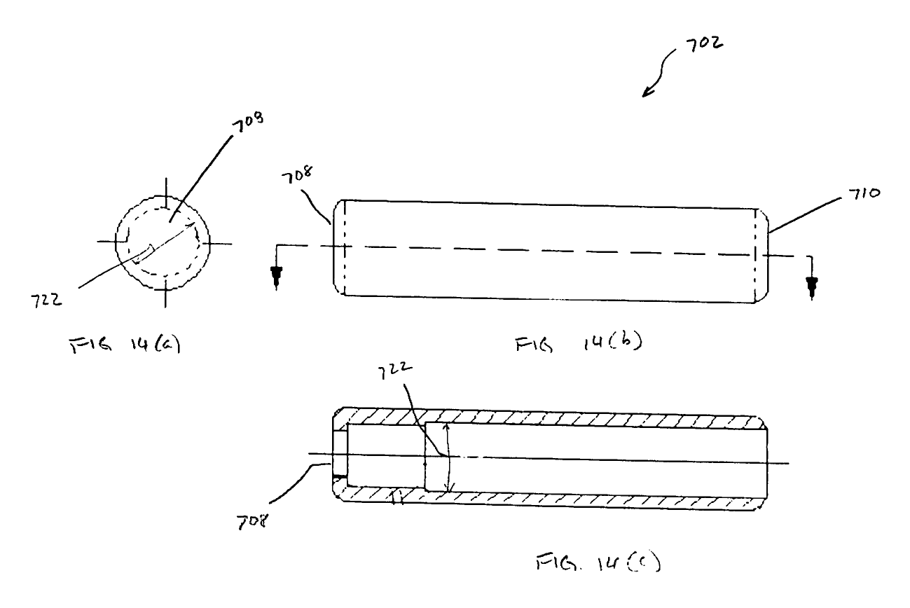

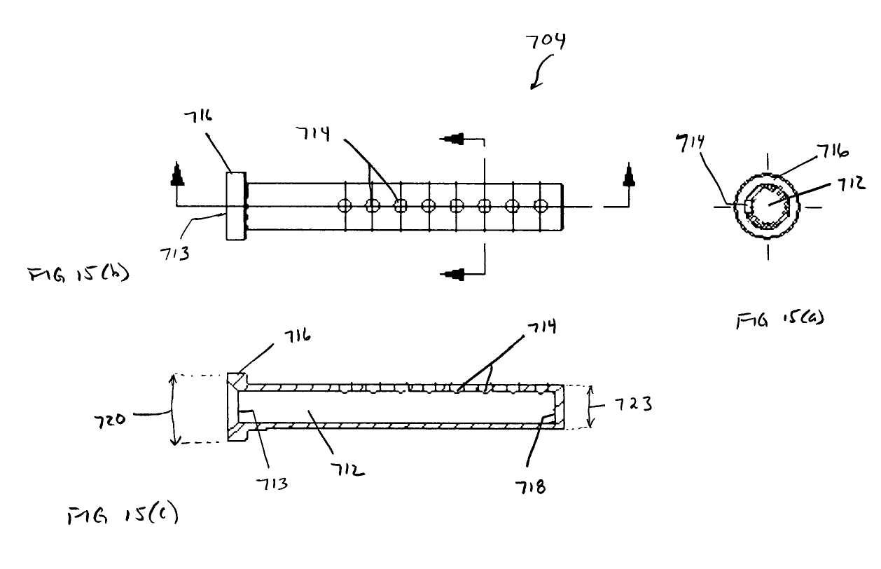

Turning to FIG. 13, a spray tube 700 of the present invention is shown. Generally, spray tube 700 comprises a protective housing 702, a nozzle 704 and a spring 706. As described in more detail below, the nozzle 704 and spring 706 are disposed within said housing during non-use. In practice, one end of spray tube 700 is coupled to a tube 50 through which water from a supply source, not shown, is modulated as described above. Referring also now to FIGS. 14(a)-14(c) showing end, top and side cutaway views respectively, of housing 702. Housing 702 has a first open end 708 to communicate with a water supply and a second open end 710 downstream first end 708. Housing 702 has an internal diameter 722. As will be explained below, nozzle 704 is generally contained within the internal diameter 722 of housing 702, e.g., housing 702 has sufficient length to contain nozzle 704.

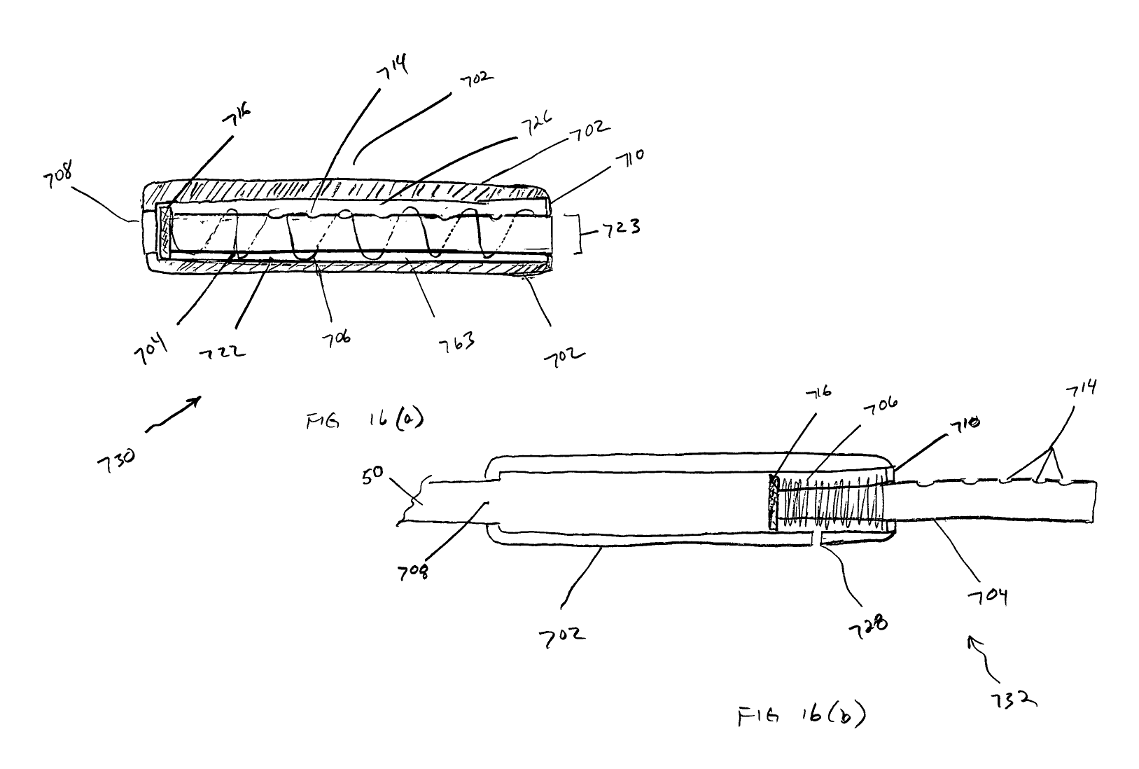

FIGS. 15(a)-15(c) show end, top and side cutaway views respectively, of nozzle 704. Nozzle 704 has a first open end 713 and a second closed end 718 defining a cavity 712 wherein cavity has a plurality of radial holes 714. The first open end 713 of cavity 712 is surrounded by a collar 716 having an external diameter 720. Adjacent collar 716 is a length of nozzle 704 having an external diameter 723 that is less than the external diameter of collar 716. FIG. 16 (a), shows a side cutaway view, of nozzle 704 generally contained within housing 702, wherein an air space 726, is created between the internal diameter 722 of housing and the external diameter 723 of nozzle 704. The first end 713 of nozzle 702 cavity 712 is open and adapted to receive water directed from a supply to tube 50 towards the first open end 708, the upstream end, of housing 702.

A coil spring 706, wound about nozzle 702 is generally confined between the collar 716 of nozzle 704 and the second downstream end 710 of housing 702. In this relation, spring 706 tends to urge collar 716 towards the first upstream end 708 of housing 702; that is, spring 706 tends to retain nozzle 704 within the housing 702 such that nozzle 704 is protected from droppings of either fecal matter or urine caused by usual toilet facility activities. This position, best seen in FIG. 16(a), is described herein as the first nozzle position 730. When water from the supply is directed into the upstream end 708 of housing 702, water is also directed into cavity 712 of nozzle 704, through holes 714 and into airspace 726 such that an external surface of nozzle 704 is bathed with clean water. Water so directed tends to urge collar 716 from its first position proximate the upstream end 708 of housing 702 towards the downstream end 710 of housing 702, best seen in FIG. 16 (b), such that nozzle is exposed and water discharges from holes 714 towards the underside of the torso of a person seated upon the seat. This extended nozzle position 732 outside the housing 702 is described herein as the second nozzle position. Collar 716 has a diameter larger than second open end 710 of housing 702. In some embodiments, housing 702 has at least one hole 728 therethrough such that water delivered into the air space 726 is directed through hole 728 into the toilet bowl. When water from the supply is turned off, spring 706 urges nozzle 704 to retract to the first nozzle position 730, e.g., back into housing 702.

A method of cleaning nozzle 704 is also provided comprising the steps of directing water to a housing 700 having a upstream end 708 with respect to the water supply and a second downstream end 710, the housing containing a nozzle 704 having cavity 712; directing water through the cavity 712 of nozzle 704 and through a plurality of holes 714 to bathe the external surface of nozzle 704 with water; whereby the nozzle moves from a first nozzle position to a second nozzle position; and cleaning the nozzle 704. The method also includes the additional steps wherein turning the water from the supply off, the nozzle 704 is urged by a spring 706 to move from its second nozzle position 732 towards the first nozzle position 703 within housing 702.

While I have shown certain embodiments of the present invention it is to be understood that it is subject to modifications and changes without departing from the spirit and scope of the invention.

1-12. (canceled)

13. A method of cleaning an external surface of a nozzle including a plurality of holes along a length thereof and a collar at end one for retaining a coil spring in place therearound comprising the steps of:
directing water to said housing containing the nozzle having a first open end and a second downstream end, the first open end in communication with a water supply;
directing water into a cavity of the nozzle and through the plurality of holes along a length thereof to clean said external surface of the nozzle while the nozzle remains in the housing before directed water compresses the coil spring thereby forcing the nozzle from a first nozzle position within the housing to a second nozzle position outside of the housing allowing directed water and fecal matter from the housing and nozzle to drain into a toilet bowl; and
ceasing directing water thereby causing said coil spring to extend and the nozzle to automatically return to the first nozzle position when said water supply is turned off.

14. (canceled)

15. The method of claim 13 further comprising coupling the housing with a tube of a bidet device.

16-17. (canceled)
